(19) United States
(12) Patent Application Publication
(10) Pub. No.: US 2025/0035822 A1
(43) Pub. Date: Jan. 30, 2025

(54) SURFACE LAYER, OPTICAL MEMBER, EYEGLASSES, AND MATERIAL FOR FORMING SURFACE LAYER

(71) Applicant: CANON OPTRON, INC., Ibaraki (JP)

(72) Inventors: Hiroto NUMAZAWA, Ibaraki (JP); Naoyuki KAWAME, Tochigi (JP)

(21) Appl. No.: 18/912,949

(22) Filed: Oct. 11, 2024

Related U.S. Application Data
(63) Continuation of application No. PCT/JP2023/002999, filed on Jan. 31, 2023.

(30) Foreign Application Priority Data
Jul. 22, 2022 (JP) 2022-117421

(51) Int. Cl. G02B 1/18; C09D 123/02; C09D 183/04; G02B 1/11; G02C 7/02

(52) U.S. Cl. CPC G02B 1/18; C09D 123/025; C09D 183/04; G02B 1/11; G02C 7/02

(57) ABSTRACT

A surface layer comprising at least a component A and a component B, wherein the component A has a siloxane segment containing a siloxane bond, the component B is an alkyl compound having an organic segment having at least one bond selected from the group consisting of a saturated hydrocarbon bond, an unsaturated hydrocarbon bond, a carbon-oxygen double bond, and a carbon-nitrogen double bond, and having a structure represented by a specific general formula, and compositional ratio of the component B to the component A in the surface layer is from 0.04 to 3.00.

### CROSS REFERENCE TO RELATED APPLICATIONS

This application is a Continuation of PCT International Application No. PCT/JP2023/002999, filed on Jan. 31, 2023, which is claiming priority of Japanese Patent Application No. 2022-117421, filed on Jul. 22, 2022, all of which are hereby expressly incorporated by reference into the present application.

### BACKGROUND OF THE INVENTION

### Field of the Invention

The present disclosure relates to a surface layer that exhibits excellent machinability and excellent stain repellency, an optical member comprising the surface layer, and spectacles comprising the optical member.

The present disclosure also relates to a material for forming a surface layer that is capable of forming a surface layer exhibiting excellent machinability and excellent stain repellency; a surface layer formed by using the material for forming the surface layer; an optical member comprising the surface layer; and spectacles comprising the optical member.

### Description of the Related Art

Optical members such as anti-reflection films, optical filters, optical lenses, and spectacle lenses typically have anti-reflection films made of inorganic materials to suppress light reflection. Anti-reflection films made of inorganic materials exhibit high surface free energies. Due to such high surface free energy, stains such as those caused by fingerprints, sebum, sweat, or cosmetics originating from the user often adhere on the anti-reflection film after human use. Besides, these adhered stains cause other problems in that they are difficult to remove from the film. As a means to solve these problems concerning the adhesion and removal of stains, Japanese Unexamined Patent Application Publication No. 2000-144097 and Japanese Unexamined Patent Application Publication No. 2003-238577 propose techniques for rendering surface properties to the optical member so that stains are less likely to adhere to the surface and any stain that adhered onto the surface can be easily removed therefrom.

However, if the surface of an optical member is provided with properties that make any stain less likely to adhere thereto and also make any adhered stain easy to remove (hereinafter, such properties are also referred to as “stain repellency” or “stain-repellent properties”), such a surface exhibits reduced frictional force, making the surface slippery. This causes problems in machining the optical member into the desired shape because the optical member is difficult to hold securely during machining.

As a countermeasure to the above problems, Japanese Unexamined Patent Application Publication No. 2013-050652 discloses a spectacle lens including an oil-repellent coating film formed on the lens and a protective film formed on the oil-repellent coating film, wherein the protective film is formed from a coating solution containing a resin made of an organic compound, inorganic oxide fine particles, and, as an active component, an organic silicon compound represented by a defined general formula or a hydrolysate thereof. By adjusting the compositional ratio of the resin made of an organic compound to the inorganic oxide fine particles, along with adjusting the content of the organic silicon compound represented by a defined general formula or a hydrolysate thereof to be within a predetermined range, edge machining of the spectacle lens using conventional or similar holding means can be carried out without difficulty, even if the oil-repellent coating film is present.

Furthermore, Japanese Unexamined Patent Application Publication No. 2005-003817 discloses a spectacle lens having a stain-repellent layer that is formed on the surface of the lens using two or more silane compounds, at least one of which silane compounds being a fluorine-containing silane compound. When the highest dynamic friction coefficient value of the lens surface, which value being determined for the lens surface formed using each of the two or more silane compounds as a sole component, is 1.4 times or higher than the lowest one, the slipperiness of the lens surface can be reduced to a level that allows the lens edge machining without impairing the superior stain-repellent effect of the stain-repellent layer.

### SUMMARY OF THE INVENTION

Nevertheless, the means for solving the problems described in Japanese Unexamined Patent Application Publication No. 2013-050652 and Japanese Unexamined Patent Application Publication No. 2005-003817 is not sufficient in terms of immovability of lens during machining, and therefore, it is still desired to obtain a stain-repellent surface that provides both the immovability of lens during machining and the stain-repellent properties in a more balanced fashion.

The present disclosure provides a surface layer that enables secure holding of the surface layer during machining while still exhibiting stain-repellent properties, and also provides an optical member and spectacles comprising the surface layer. The present disclosure also provides a material for forming a surface layer for forming a surface layer that enables secure holding of the surface layer during machining while exhibiting stain-repellent properties.

The surface layer according to the present disclosure is a surface layer comprising at least a component A and a component B, wherein
the component A has a siloxane segment containing a siloxane bond,
the component B is an alkyl compound having an organic segment having at least one bond selected from the group consisting of a saturated hydrocarbon bond, an unsaturated hydrocarbon bond, a carbon-oxygen double bond, and a carbon-nitrogen double bond, and having a structure represented by a following general formula (3):

$${R}_{3} - Y - {R}_{4} ; \qquad ( 3 )$$

a segment represented by Y comprises one or more segments containing at least one bond selected from the group consisting of [CᵢH₂ᵢ₋₂]ⱼ₁, [CᵢH₂ᵢ]ⱼ₂, [C₆H₄]ⱼ₃, [Cᵢ₊₁H₂ᵢ₋₁Cl]ⱼ₄, [CᵢHᵢCl]ⱼ₅, [C₅H₄O₃]ⱼ₆, [C₃H₆N]ⱼ₇, and [C₄H₆O₂N]ⱼ₈,
the i, j₁, j₂, j₃, j₄, j₅, j₆, j₇, and j₈ satisfy 32≤i×(i+j₂+j₃+j₄+j₅+j₆+j₇+j₈)≤750,
the j₁, j₂, j₃, j₄, j₅, j₆, j₇, and j₈ are each independently an integer of 0 or more, and
the i is, independently for each of the segment, an integer of 1 or more; and
the R₃ and R₄ are each independently a hydrolyzable group, a silanol group, a hydroxy group, a reactive organic group, an organic group containing a hydrolyzable group-containing silyl group, an alkylsilyl group, or a hydrogen atom, and
   a compositional ratio of the component B to the component A in the surface layer is from 0.04 to 3.00.

Also, the optical member of the present disclosure is an optical member comprising the aforementioned surface layer.

Furthermore, the eyeglasses of the present disclosure are eyeglasses comprising the aforementioned optical member.

Furthermore, a material for forming a surface layer of the present disclosure is a material for forming a surface layer comprising at least a component A and a component B, wherein
the component A has at least a siloxane segment containing a siloxane bond,
the component B is an alkyl compound having an organic segment having at least one bond selected from the group consisting of a saturated hydrocarbon bond, an unsaturated hydrocarbon bond, a carbon-oxygen double bond, and a carbon-nitrogen double bond, and having a structure represented by a following general formula (3):

$${R}_{3} - Y - {R}_{4} ; \qquad ( 3 )$$

a segment represented by Y comprises one or more segments containing at least one bond selected from the group consisting of [CᵢH₂ᵢ₋₂]ⱼ₁, [CᵢH₂ᵢ]ⱼ₂, [C₆H₄]ⱼ₃, [Cᵢ₊₁H₂ᵢ₋₁Cl]ⱼ₄, [CᵢHᵢCl]ⱼ₅, [C₅H₄O₃]ⱼ₆, [C₃H₆N]ⱼ₇, and [C₄H₆O₂N]ⱼ₈,
the i, j₁, j₂, j₃, j₄, j₅, j₆, j₇, and j₈ satisfy 32≤i×(i+j₂+j₃+j₄+j₅+j₆+j₇+j₈)≤750,
the j₁, j₂, j₃, j₄, j₅, j₆, j₇, and j₈ are each independently an integer of 0 or more, and
the i is, independently for each of the segment, an integer of 1 or more; and
the R₃ and R₄ are each independently a hydrolyzable group, a silanol group, a hydroxy group, a reactive organic group, an organic group containing a hydrolyzable group-containing silyl group, an alkylsilyl group, or a hydrogen atom, and
a mass ratio of the component B to the component A in the material for forming the surface layer is from 0.04 to 3.00.

According to the present disclosure, a surface layer that enables secure holding of the surface layer during machining while exhibiting stain-repellent properties as well as an optical member and spectacles comprising the surface layer can be provided. The present disclosure can also provide a material for forming a surface layer for forming a surface layer that enables secure holding of the surface layer during machining while exhibiting stain-repellent properties. Further features of the present invention will become apparent from the following description of exemplary embodiments with reference to the attached drawings.

### BRIEF DESCRIPTION OF THE DRAWINGS

FIG. 1 is a schematic view showing the configuration of the surface layer in a first embodiment of the present invention;

FIG. 2 is a schematic view showing the configuration of the surface layer in a second embodiment of the present invention;

FIG. 3 is a schematic view showing the configuration of the optical member in the first embodiment of the present invention;

FIG. 4 is a schematic view showing the configuration of the optical member in the second embodiment of the present invention; and

FIG. 5 is a schematic view showing the configuration of the spectacles in one embodiment in which the optical members are used.

### DESCRIPTION OF THE EMBODIMENTS

Hereinbelow, embodiments of a surface layer according to the present disclosure, an optical member comprising the surface layer, and spectacles comprising the optical member as well as an embodiment of a material for forming a surface layer according to the present disclosure will be described with reference to preferred embodiments of the present disclosure. However, the present disclosure is not limited to the embodiments described below.

Throughout the present disclosure, the recitation of numerical ranges such as “from XX to YY” or “XX to YY” indicate the numerical ranges including the upper and lower endpoints of the range, unless otherwise stated. Additionally, if a plurality of numerical ranges are described in a stepwise manner, any upper endpoint of the indicated numerical ranges may be combined with any lower endpoint of the indicated numerical ranges.

According to the present disclosure, it is possible to suppress slipping of a base material or an optical member when a high load is applied to the surface layer of the base material or the optical member, by maintaining the frictional force generated on the surface layer at a higher level, thereby allowing secure holding of the base material or the optical member during machining thereof. Furthermore, when the load applied to the surface layer of the base material or the optical member is within the range typically applied by users during normal daily use of the base material or the optical member, the frictional force generated on the surface layer becomes low, while simultaneously allowing the surface layer to exhibit stain-repellent properties. As a result of that, a surface layer that exhibits both machinability and stain-repellent properties, an optical member comprising the surface layer, and spectacles comprising the optical member can be provided. Furthermore, a material for forming a surface layer that provides the aforementioned properties to the surface layer can also be provided.

The present inventors believe that the surface layer according to the present disclosure and the optical member comprising the surface layer achieve both immovability during machining and stain-repellent properties through the following mechanism.

As component A contained in the surface layer, a compound having a siloxane segment containing a siloxane bond is chosen. In addition to that, as component B, a compound having an organic segment having at least one bond selected from the group consisting of a saturated hydrocarbon bond, an unsaturated hydrocarbon bond, a carbon-oxygen double bond, and a carbon-nitrogen double bond is chosen.

Component A, which has a siloxane segment containing siloxane bonds, provides stain-repellent properties, but at the same time tends to lower the frictional force under load. The present inventors believe that this occurs by the following reasons: as described in Technology outlook series: Silicone outlook (Gijutu-taizen series: Silicone Taizen), pp. 10-11, the siloxane bond consists of a silicon atom and an oxygen atom and is represented by the following chemical formula (1):

Si—O—Si (1).

The bond between the silicon and the oxygen in the above formula (1) has flexible characteristics as the energy required to rotate the bond between the silicon and the oxygen is as low as 0.8 kJ/mol or lower. Due to this characteristics, it is believed that when a load is applied to a surface having a siloxane segment having a siloxane bond in an attempt to hold the surface tightly, the siloxane segment having the siloxane bond deforms, thereby allowing the applied force to be diverted, resulting in the reduction in the frictional force.

On the other hand, since the component B has an organic segment having at least one bond selected from a saturated hydrocarbon bond, an unsaturated hydrocarbon bond, a carbon-oxygen double bond and a carbon-nitrogen double bond, the component B is less deformable under load compared to the siloxane bond in component A, thereby showing a tendency to generate a higher frictional force.

Thus, when the surface layer containing at least component A and component B is brought into contact with an object that applies a high load to the surface layer, the molecules of component B resist deformation, whereas the molecules of component A may deform. Therefore, if the proportion of component B that comes into contact with the object is higher, the surface layer in contact with the object can exhibit a higher frictional force. Furthermore, if component B has an organic segment having at least one bond selected from the group consisting of an unsaturated hydrocarbon bond, a carbon-oxygen double bond, and a carbon-nitrogen double bond, component B is even less deformable under load, generating a higher frictional force, and is therefore preferable.

With consideration of the foregoing, by adjusting the compositional ratio of component B to component A in the surface layer within a predetermined range, it is possible to achieve a high stain-repellent properties when the load applied by the object coming into contact with the surface layer is low.

“Surface layer” refers to the interface in contact with both of the base material and other solid, liquid or gas. In other words, “surface layer” as used herein refers to the surface of the base material, and therefore, the present specification also discloses the base material having such a surface.

As the base material, any solid material may be used as long as undercoat layer 12, surface layer 13, intermediate layer 14, or hard coating layer 15 described in detail below can be formed on the base material; however, glass, ceramic, resin, or metal, or films made from materials such as glass or resin may be preferred.

Optical member refers to an optical member that comprises a base material having the aforementioned surface layer. Examples of the optical member include optical filters, optical lenses, spectacle lenses, photographic lenses, display cover glasses, display touch panels, and various films.

Spectacles refer to spectacles that have the aforementioned optical member. The spectacles are not limited to ordinary vision correction spectacles, but also encompass all devices worn around the eyes, including non-prescription glasses, protective goggles, head-mount displays, sunglasses, and smart glasses.

Component A according to the present disclosure will be described hereinbelow.

Component A has a siloxane segment containing a siloxane bond. The siloxane segment containing the siloxane bond is preferably at least one segment selected from the group consisting of dimethylsiloxane segment, diphenylsiloxane segment, methylphenylsiloxane segment, methylhydrogensiloxane segment, and phenylhydrogensiloxane segment, and more preferably at least one segment selected from the group consisting of dimethylsiloxane segment, diphenylsiloxane segment and methylphenylsiloxane segment.

Specifically, component A is, for example, a compound having a structure represented by the following general formula (2):

$${R}_{1} - X - {R}_{2} \qquad ( 2 )$$

and is preferably at least one compound selected from the group consisting of dimethylsiloxane compounds, diphenylsiloxane compounds, methylphenylsiloxane compounds, methylhydrogensiloxane compounds and, phenylhydrogensiloxane compound, and is more preferably at least one compound selected from the group consisting of dimethylsiloxane compounds, diphenylsiloxane compounds and methylphenylsiloxane compounds.

In a preferred aspect, the segment represented by X in the formula (2) comprises at least one segment or any combination thereof selected from the segments listed in Table 1 below.

TABLE 1

| | |
|---|---|
| [SiC₂H₆—O]ₘ₁ | [SiC₁₂H₁₀—O]ₘ₂ |
| [SiC₇H₈—O]ₘ₃ | [SiCH₄—O]ₘ₄ |
| [SiC₆H₆—O]ₘ₅ | |

In the table above, SiC₂H₆ denotes —Si(CH₃)₂—, SiC₇H₈ denotes —Si(CH₃)Ph, SiC₆H₆ denotes —SiHPh-, SiC₁₂H₁₀ denotes —Si(Ph)₂-, and SiCH₄ denotes —Si(CH₃)H—. Ph denotes phenyl group.

In Table 1, m₁, m₂, m₃, m₄, and m₅ preferably satisfy 2≤m₁+m₂+m₃+m₄+m₅≤150. A more preferred range of m₁+m₂+m₃+m₄+m₅ is 5≤m₁+m₂+m₃+m₄+m₅≤120, and further preferred range is 10≤m₁+m₂+m₃+m₄+m₅≤50.

In Table 1, m₁, m₂, m₃, m₄, and m₅ are each independently an integer of 0 or more. That is, the values of m₁, m₂, m₃, m₄, and m₅ in Table 1 may vary from segment to segment.

Here, when any of m₁, m₂, m₃, m₄, and m₅ is 0, the corresponding segment in Table 1 is absent in the segment represented by X in the formula (2). In Table 1, “O” denotes an oxygen atom that forms the siloxane bond.

In addition, the side chains of the segment represented by X may be partially substituted with an organic group such as an amino group, an epoxy group, a thiol group, a carboxy group, a polyether group, a long-chain alkyl group, and fluoroalkyl group.

The R₁ and R₂ in the general formula (2) are preferably each independently a hydrolyzable group, a silanol group, a hydroxy group, a reactive organic group, an organic group containing a hydrolyzable group-containing silyl group, an alkylsilyl group, or a hydrogen atom. Examples of hydrolyzable groups include alkoxy groups with 1 to 10 carbon atoms such as methoxy group, ethoxy group, propoxy group and butoxy group; alkoxyalkoxy groups with 2 to 10 carbon atoms such as methoxymethoxy group and methoxyethoxy group; acyloxy groups with 1 to 10 carbon atoms such as acetoxy group; alkenyloxy groups with 2 to 10 carbon atoms such as isopropenoxy group; halogen groups such as chloro group, bromo group and iodo group; and an amino group. Among these, methoxy group, ethoxy group, isopropenoxy group, and chloro group are particularly suitable. Examples of reactive organic groups include methacryl group, carboxy group, epoxy group, thiol group, and the like. Among these, methacryl group and carboxy group are particularly suitable.

The organic group containing hydrolyzable group-containing silyl group is, for example, an organic group in which a hydrolyzable group is directly or indirectly bonded to the silicon atom. Examples of hydrolyzable groups include alkoxy groups with 1 to 10 carbon atoms such as methoxy group, ethoxy group, propoxy group and butoxy group; alkoxyalkoxy groups with 2 to 10 carbon atoms such as methoxymethoxy group and methoxyethoxy group; acyloxy groups with 1 to 10 carbon atoms such as acetoxy group; alkenyloxy groups with 2 to 10 carbon atoms such as isopropenoxy group; halogen groups such as chloro group, bromo group and iodo group; and an amino group. The number of hydrolyzable groups in the organic group containing a hydrolyzable group-containing silyl group is preferably from 1 to 3, more preferably from 2 or 3, even more preferably 3. The organic group containing a hydrolyzable group-containing silyl group may have an alkylsilyl group described below. Namely, examples of the organic groups containing a hydrolyzable group-containing silyl group include trimethoxysilyl group, dimethoxymethylsilyl group, ethyldimethoxysilyl group, methoxydimethylsilyl group, diethylmethoxysilyl group, ethylmethoxymethylsilyl group, triethoxysilyl group, diethoxyethylsilyl group, diethoxymethylsilyl group, ethoxydiethylsilyl group, and ethoxyethylmethylsilyl group.

Examples of the alkylsilyl groups include alkylsilyl groups with 1 to 10 carbon atoms, and the numbers of carbon atoms in the alkylsilyl group is preferably 1 to 5, more preferably 1 to 3, and particularly preferably 1. The number of the alkyl group is preferably 1 to 3, more preferably 2 to 3, further preferably 3. Therefore, examples of the alkylsilyl group include trimethylsilyl group, triethylsilyl group, ethyldimethylsilyl group, and diethylmethylsilyl group.

Specific examples of component A may include compounds listed in Table 2-1 and Table 2-2, but are not limited to these compounds.

As component A, the compound having a siloxane segment having a siloxane bond may be used alone or in combination of two or more of such compounds.

TABLE 2-1

| No. | Structure of component A |
|---|---|
| A-1 | (MeO)₃—Si—O—[SiC₂H₆—O]₂—Si—(CH₃)₃ |
| A-2 | (MeO)₃—Si—O—[SiC₂H₆—O]₁₀—Si—(CH₃)₃ |
| A-3 | (MeO)₃—Si—O—[SiC₂H₆—O]₁₈—Si—(CH₃)₃ |
| A-4 | (MeO)₃—Si—O—[SiC₂H₆—O]₃₀—Si—(CH₃)₃ |
| A-5 | (MeO)₃—Si—O—[SiC₂H₆—O]₅₀—Si—(CH₃)₃ |
| A-6 | (MeO)₃—Si—O—[SiC₂H₆—O]₁₅₀—Si—(CH₃)₃ |
| A-7 | (EtO)₃—Si—O—[SiC₂H₆—O]₅—Si—(CH₃)₃ |
| A-8 | (EtO)₃—Si—O—[SiC₂H₆—O]₁₈—Si—(CH₃)₃ |
| A-9 | (EtO)₃—Si—O—[SiC₂H₆—O]₃₀—Si—(CH₃)₃ |
| A-10 | (EtO)₃—Si—O—[SiC₂H₆—O]₁₂₀—Si—(CH₃)₃ |
| A-11 | HO—[SiC₂H₆—O]₁₈—Si—(CH₃)₃ |
| A-12 | HO—[SiC₂H₆—O]₁₂₀—Si—(CH₃)₃ |
| A-13 | H—[SiC₂H₆—O]₃₀—Si—(CH₃)₃ |
| A-14 | C₄H₅O₂—[SiC₂H₆—O]₃₀—Si—(CH₃)₃ |
| A-15 | C₄H₅O₂—[SiC₂H₆—O]₁₅₀—Si—(CH₃)₃ |
| A-16 | (MeO)₃—Si—O—[SiC₂H₆—O]₂—Si—(MeO)₃ |
| A-17 | (MeO)₃—Si—O—[SiC₂H₆—O]₁₀—Si—(MeO)₃ |
| A-18 | (MeO)₃—Si—O—[SiC₂H₆—O]₃₀—Si—(MeO)₃ |
| A-19 | (MeO)₃—Si—O—[SiC₂H₆—O]₁₂₀—Si—(MeO)₃ |
| A-20 | HO—[SiC₂H₆—O]₃₀—Si—OH |

TABLE 2-2

| No. | Structure of component A |
|---|---|
| B-1 | (MeO)₃—Si—O—[SiC₂H₆—O]₈—[SiC₁₂H₁₀—O]₂—Si—(CH₃)₃ |
| B-2 | (MeO)₃—Si—O—[SiC₂H₆—O]₂₅—[SiC₁₂H₁₀—O]₅—Si—(CH₃)₃ |
| B-3 | HO—[SiC₂H₆—O]₁₆—[SiC₁₂H₁₀—O]₂—Si—(CH₃)₃ |
| B-4 | HO—[SiC₂H₆—O]₄₀—[SiC₁₂H₁₀—O]₁₀—Si—(CH₃)₃ |
| B-5 | (MeO)₃—Si—O—[SiC₂H₆—O]₁₅—[SiC₁₂H₁₀—O]₃—Si—(MeO)₃ |
| B-6 | (MeO)₃—Si—O—[SiC₂H₆—O]₁₂₅—[SiC₁₂H₁₀—O]₂₅—Si—(MeO)₃ |
| B-7 | (MeO)₃—Si—O—[SiC₂H₆—O]₁₀₀—[SiC₁₂H₁₀—O]₂₀—Si—(CH₃)₃ |
| C-1 | (MeO)₃—Si—O—[SiC₂H₆—O]₇—[SiC₇H₈—O]₃—Si—(CH₃)₃ |
| C-2 | (MeO)₃—Si—O—[SiC₂H₆—O]₄₀—[SiC₇H₈—O]₁₀—Si—(CH₃)₃ |
| C-3 | C₄H₅O₂—[SiC₂H₆—O]₁₅—[SiC₇H₈—O]₃—C₄H₅O₂ |
| D-1 | (MeO)₃—Si—O—[SiC₂H₆—O]₈—[SiCH₄—O]₂—Si—(CH₃)₃ |
| D-2 | (MeO)₃—Si—O—[SiC₂H₆—O]₄₅—[SiCH₄—O]₅—Si—(CH₃)₃ |
| D-3 | (MeO)₃—Si—O—[SiC₂H₅—O]₁₃₀—[SiCH₄—O]₂₀—Si—(CH₃)₃ |
| D-4 | C₄H₅O₂—[SiC₂H₆—O]₂₂—[SiCH₄—O]₈—Si—(CH₃)₃ |
| D-5 | C₄H₅O₂—[SiC₂H₆—O]₁₁₀—[SiCH₄—O]₁₀—Si—(CH₃)₃ |
| D-6 | (EtO)₃—Si—O—[SiC₂H₆—O]₁₅—[SiCH₄—O]₃—Si—(EtO)₃ |
| D-7 | (EtO)₃—Si—O—[SiC₂H₆—O]₁₄₀—[SiCH₄—O]₁₀—Si—(EtO)₃ |
| E-1 | (MeO)₃—Si—O—[SiC₂H₆—O]₁₃—[SiC₁₂H₁₀—O]₃—[SiCH₄—O]₂—Si—(CH₃)₃ |
| E-2 | (MeO)₃—Si—O—[SiC₂H₆—O]₃₅—[SiC₆H₆—O]₁₀—[SiCH₄—O]₅—Si—(CH₃)₃ |
| E-3 | HOOC—[SiC₂H₆—O]₂₂—[SiC₁₂H₁₀—O]₅—[SiCH₄—O]₃—Si—(CH₃)₃ |

In Table 2-1 and Table 2-2, SiC₂H₆ denotes —Si(CH₃)₂—, SiC₇H₈ denotes —Si(CH₃)Ph-, SiC₆H₆ denotes —SiHPh-, SiC₁₂H₁₀ denotes —Si(Ph)₂-, SiCH₄ denotes —Si(CH₃)H—, and C₄H₅O₂ denotes methacryl group. Me denotes methyl group, Et denotes ethyl group, and Ph denotes phenyl group.

Component B according to the present disclosure will be described hereinbelow.

Component B has an organic segment having at least one bond selected from the group consisting of a saturated hydrocarbon bond, an unsaturated hydrocarbon bond, a carbon-oxygen double bond, and a carbon-nitrogen double bond.

Preferably, component B has an organic segment having an unsaturated hydrocarbon bond, and the unsaturated hydrocarbon bond is derived from at least one compound selected from the group consisting of 1,2-polybutadiene, 1,4-polybutadiene, 1,2-polyisoprene, 1,4-polyisoprene, 1,2-polychloroprene, and 1,4-polychloroprene. More preferably, the unsaturated hydrocarbon bond is derived from at least one compound selected from the group consisting of 1,2-polybutadiene and 1,2-polyisoprene.

Here, the expression “the unsaturated hydrocarbon bond is derived from the aforementioned at least one compound” means that the unsaturated hydrocarbon bond contained in the organic segment corresponds to the unsaturated hydrocarbon bond contained in the aforementioned at least one compound.

In another preferred aspect, component B has a polyolefin, in a side chain, an organic segment having at least one bond selected from the group consisting of an unsaturated hydrocarbon bond, a carbon-oxygen double bond and a carbon-nitrogen double bond.

More specifically, component B is, for example, an alkyl compound having a structure represented by the following general formula (3):

$${R}_{3} - Y - {R}_{4} \qquad ( 3 )$$

Herein, when component B is the compound having a structure represented by the above general formula (3), the segment referred to as “an organic segment containing at least one bond selected from the group consisting of a saturated hydrocarbon bond, an unsaturated hydrocarbon bond, a carbon-oxygen double bond, and a carbon-nitrogen double bond” corresponds to the segment represented by “Y” in the above general formula (3).

The segment represented by “Y” in the above general formula (3) contains one or more segments containing at least one bond selected from the group consisting of saturated hydrocarbon bonds, unsaturated hydrocarbon bonds, carbon-oxygen double bonds, and carbon-nitrogen double bonds shown in Table 3. Additionally, the saturated hydrocarbon bond, the unsaturated hydrocarbon bond, the carbon-oxygen double bond, and the carbon-nitrogen double bond may be present in the segment either as a single bond or as a combination of two or more of the bonds of the same or different types.

TABLE 3

| | | |
|---|---|---|
| [CᵢH₂ᵢ₋₂]ⱼ₁ | [Cᵢ₊₁H₂ᵢ₋₁Cl]ⱼ₄ | [C₃H₆N]ⱼ₇ |
| [CᵢH₂ᵢ]ⱼ₂ | [CᵢHᵢCl]ⱼ₅ | [C₄H₆O₂N]ⱼ₈ |
| [C₆H₄]ⱼ₃ | [C₅H₄O₃]ⱼ₆ | |

In this table, C₆H₄ represents phenylene group.

In Table 3, i and j₁, j₂, j₃, j₄, j₅, j₆, j₇, and j₈ preferably satisfy 32≤i×(j₁+j₂+j₃+j₄+j₅+j₆+j₇+j₈)≤750, and more preferably satisfy 40≤i×(j₁+j₂+j₃+j₄+j₅+j₆+j₇+j₈)≤180.

In Table 3, i is each independently an integer of 1 or more, and the value of i in one segment may be different from the value in another segment.

In Table 3, j₁, j₂, j₃, j₄, j₅, j₆, j₇, and j₈ are each independently an integer of 1 or more. In other words, in Table 3, the respective value of j₁, j₂, j₃, j₄, j₅, j₆, j₇, and j₈ in one segment may be different from the respective ones in another segment.

Here, when any of j₁, j₂, j₃, j₄, j₅, j₆, j₇, and j₈ is 0, the corresponding segment in Table 3 is absent in the segment represented by Y in formula (3).

As long as the above: i×(j₁+j₂+j₃+j₄+j₅+j₆+j₇+j₈) lies within the possible range, the segment represented by Y may be branched in the middle of the main molecular chain to have a side chain which is composed of a segment having at least one bond selected from the group consisting of a saturated hydrocarbon bond, an unsaturated hydrocarbon bond, a carbon-oxygen double bond, and a carbon-nitrogen double bond.

In Table 3, C₅H₄O₃ denotes a bond formed through grafting maleic anhydride onto a part of side chains of a polyolefin such as polyethylene or polypropylene.

Furthermore, in Table 3, C₃H₆N denotes a bond in which a part of side chains of a polyolefin such as polyethylene or polypropylene is substituted with an amino group.

Furthermore, in Table 3, C₄H₆O₂N denotes a bond in which a part of side chains of a polyolefin such as polyethylene or polypropylene is substituted with an isocyanate group.

The segment represented by “Y” in the above general formula (3) preferably contains one or more segments containing at least one bond selected from the group consisting of the saturated hydrocarbon bonds, the unsaturated hydrocarbon bonds, the carbon-oxygen double bonds, and the carbon-nitrogen double bonds shown in Table 4.

TABLE 4

| No. | Segment |
|---|---|
| Y-1 | 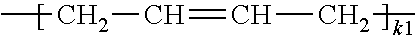 |
| Y-2 | 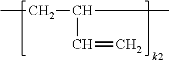 |
| Y-3 | 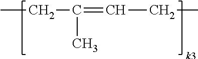 |
| Y-4 | 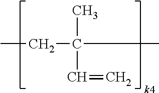 |
| Y-5 | 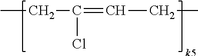 |
| Y-6 | 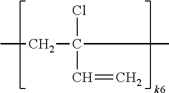 |
| Y-7 | 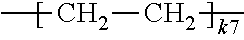 |
| Y-8 | 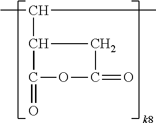 |
| Y-9 | 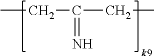 |
| Y-10 | 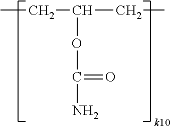 |

In Table 4, k₁, k₂, k₃, k₄, k₅, k₆, k₇, k₈, k₉, and k₁₀ preferably satisfy 8≤k₁+k₂+k₃+k₄+k₆+k₇+k₈+k₉+k₁₀≤180, and more preferably satisfy 40≤k₁+k₂+k₃+k₄+k₆+k₇+k₈+k₉+k₁₀≤120.

In Table 4, k₁, k₂, k₃, k₄, k₅, k₆, k₇, k₈, k₉, and k₁₀ are each independently an integer of 0 or more. In other words, in Table 4, the respective value of k₁, k₂, k₃, k₄, k₅, k₆, k₇, k₈, k₉, and k₁₀ in one segment may be different from the respective ones in another segment.

Here, when any of k₁, k₂, k₃, k₄, k₅, k₆, k₇, k₈, k₉, and k₁₀ is 0, the corresponding segment in Table 4 is absent in the segment represented by Y in formula (3).

As long as the above: k₁+k₂+k₃+k₄+k₆+k₇+k₈+k₉+k₁₀ lies within the possible range, the segment represented by Y may be branched in the middle of the main molecular chain to have a side chain which is composed of a segment having at least one bond selected from the group consisting of an unsaturated hydrocarbon bond, a carbon-oxygen double bond, and a carbon-nitrogen double bond.

In preferred structures of component B, any one of an unsaturated hydrocarbon bond, a carbon-oxygen double bond, or a carbon-nitrogen double bond, or any combination thereof, is present in the side chain of component B. More preferably, either an unsaturated hydrocarbon bond or a carbon-oxygen double bond, or any combination thereof, is present in the side chain.

The R₃ and R₄ in the general formula (3) may each independently be a hydrolyzable group, a silanol group, a hydroxy group, a reactive organic group, an organic group containing a hydrolyzable group-containing silyl group, an alkylsilyl group, or a hydrogen atom. An organic group containing a hydrolyzable group-containing silyl group, a hydroxy group, and a hydrogen atom are preferred. A hydroxy group and a hydrogen atom are more preferred. Examples of hydrolyzable groups include alkoxy groups with 1 to 10 carbon atoms such as methoxy group, ethoxy group, propoxy group and butoxy group; alkoxyalkoxy groups with 2 to 10 carbon atoms such as methoxymethoxy group and methoxyethoxy group; acyloxy groups with 1 to 10 carbon atoms such as acetoxy group; alkenyloxy groups with 2 to 10 carbon atoms such as isopropenoxy group; halogen groups such as chloro group, bromo group, and iodo group; and an amino group. Among these, methoxy group, ethoxy group, isopropenoxy group, and chloro group are particularly suitable. Examples of reactive organic groups include methacryl group, carboxy group, epoxy group, thiol group, and the like. Among these, methacryl group and carboxy group are particularly suitable.

Examples of the organic group containing a hydrolyzable group-containing silyl group include those in which a hydrolyzable group is directly or indirectly bonded to the silicon atom. Examples of hydrolyzable groups include alkoxy groups with 1 to 10 carbon atoms such as methoxy group, ethoxy group, propoxy group and butoxy group; alkoxyalkoxy groups with 2 to 10 carbon atoms such as methoxymethoxy group and methoxyethoxy group; acyloxy groups with 1 to 10 carbon atoms such as acetoxy group; alkenyloxy groups with 2 to 10 carbon atoms such as isopropenoxy group; halogen groups such as chloro group, bromo group, and iodo group; and an amino group. The number of hydrolyzable groups in the organic group containing a hydrolyzable group-containing silyl group is preferably from 1 to 3, more preferably from 2 or 3, even more preferably 3. The organic group containing a hydrolyzable group-containing silyl group may have an alkylsilyl group described below. Namely, examples of the organic groups containing a hydrolyzable group-containing silyl group include trimethoxysilyl group, dimethoxymethylsilyl group, ethyldimethoxysilyl group, methoxydimethylsilyl group, diethylmethoxysilyl group, ethylmethoxymethylsilyl group, triethoxysilyl group, diethoxyethylsilyl group, diethoxymethylsilyl group, ethoxydiethylsilyl group, and ethoxyethylmethylsilyl group.

Examples of the alkylsilyl groups include alkylsilyl groups with 1 to 10 carbon atoms, and the numbers of carbon atoms in the alkylsilyl group is preferably 1 to 5, more preferably 1 to 3, and particularly preferably 1. The number of the alkyl group is preferably 1 to 3, more preferably 2 to 3, further preferably 3. Therefore, examples of the alkylsilyl group include trimethylsilyl group, triethylsilyl group, ethyldimethylsilyl group, and diethylmethylsilyl group.

Specific examples of component B include the compounds listed in Table 5, but are not limited to these compounds. Additionally, as component B, a compound containing one or more segments containing at least one bond selected from the group consisting of a saturated hydrocarbon bond, an unsaturated hydrocarbon bond, a carbon-oxygen double bond, and a carbon-nitrogen double bond may be used either alone or in combination of two or more of such compounds.

TABLE 5

| No. | Structural formula of component B |
|---|---|
| a-1 | H—[CH₂—CH═CH—CH₂]₈—H |
| a-2 | HO—[CH₂]₂—[CH₂—CH═CH—CH₂]₈—[CH₂]₂—OH |
| a-3 | H—[CH₂—CH═CH—CH₂]₂₂—H |
| a-4 | 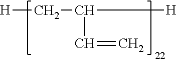 |
| a-5 | HO—[CH₂]₂—[CH₂—CH═CH—CH₂]₂₄—[CH₂]₂—OH |
| a-6 | 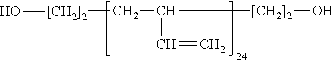 |
| a-7 | HO—[CH₂]₂—[CH₂—CH═CH—CH₂]₃₄—[CH₂]₂—OH |
| a-8 | 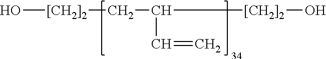 |
| a-9 | H—[CH₂—CH═CH—CH₂]₄₀—H |
| a-10 | 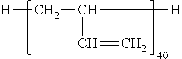 |
| a-11 | HO—[CH₂]₂—[CH₂—CH═CH—CH₂]₅₄—[CH₂]₂—OH |
| a-12 | 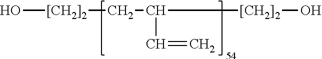 |
| a-13 | 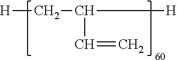 |
| a-14 | H—[CH₂—CH═CH—CH₂]₁₄₀—H |
| b-1 | 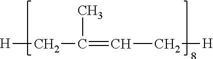 |
| b-2 | 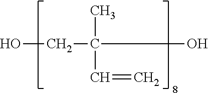 |
| b-3 | 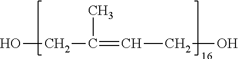 |
| b-4 | 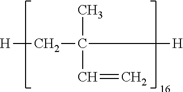 |
| b-5 | 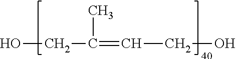 |
| b-6 | 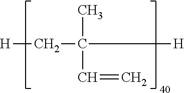 |
| c-1 | 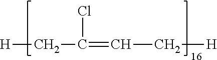 |
| c-2 | 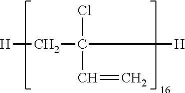 |

Specific examples of component B may also include compounds listed in Table 6, but are not limited to these compounds.

TABLE 6

| No. | Structural formula of component B |
|---|---|
| d-1 | 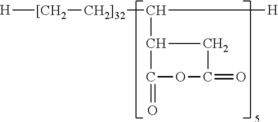 |
| d-2 | 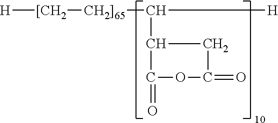 |
| d-3 | 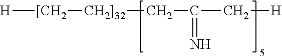 |
| d-4 | 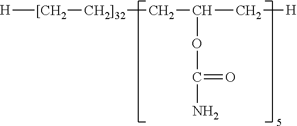 |
| d-5 | H—[CH₂—CH₂]₃₅—H |

The compounds listed in Table 6 are alkyl compounds having either a saturated hydrocarbon bond, an unsaturated hydrocarbon bond, a carbon-oxygen double bond, or a carbon-nitrogen double bond. The compounds d-1 to d-4 are modified polyolefins, in which some of their side chains are substituted with different segments. Examples of the substituent segments include imino segments, vinyl segments, carboxylic acid segments, carboxylic acid anhydride segments, ketene segments, isocyanate segments, and the like.

The compositional ratio of component B to component A in the surface layer of the present disclosure is such that P_{B}/P_{A} ranges from 0.04 to 3.00, where P_{A} is the peak intensity attributed to component A as determined by a micro-Raman spectrometry performed on the surface layer, and P_{B} is the peak intensity attributed to component B. The compositional ratio of component B to component A in the surface layer of the present disclosure may be controlled by adjusting the mass ratio of component B to component A in the material for forming the surface layer of the present disclosure. The compositional ratio is preferably from 0.10 to 1.00, and more preferably from 0.20 to 0.60.

When the compositional ratio of component B to component A is lower than 0.04, although stain-repellent properties may be achieved, the frictional force generated on the base material under a high load during machining cannot be increased, resulting in insufficient suppression of slipping of the base material, which makes it difficult to machine the base material. Whereas when the compositional ratio of component B to component A is more than 3.00, not only are the stain-repellent properties decreased, but a higher frictional force is also generated even when the load is within the range typically applied by users during normal daily use, which cause problems such as cleaning cloth snagging on the surface layer, making the surface layer uncomfortable to use.

The compositional ratio of component B to component A may be determined in the following manner:

First, a target area in the surface layer to be measured with the micro-Raman spectrometer is determined. This area is determined according to the magnification power of the objective lens attached to the spectrometer, the wavelength of the excitation laser, and the aperture diameter. Hereinbelow, the area determined is also referred to as the “measurement area.”

Next, the measurement area is irradiated by the excitation laser, and the emitted scattered light is measured to determine the Raman spectrum. The measuring conditions are as follows:
Instrument: micro-Raman spectrometer manufactured by Thermo Fisher Scientific Inc.
Objective lens magnification power: 10×
Excitation laser wavelength: 532 nm
Aperture diameter: 25 μm
Measurement area: 2 μm

In the obtained Raman spectrum, the peak attributed to the siloxane bond is defined as that derived from component A, and the intensity thereof is expressed as P_{A}. If any peak attributed to C═C bond, C═O bond, or C═N bond is observed in the Raman spectrum, the peak attributed to C═C bond, C═O bond, or C═N bond is defined as that derived from component B, and the intensity thereof is expressed as P_{B}.

If any peak attributed to C═C bond, C═O bond, or C═N bond is not observed in the Raman spectrum, the peak attributed to C—C bond is defined as that derived from component B, and the intensity thereof is expressed as P_{B}.

If the frictional force measured under the condition of the load applied to the surface layer of 14 kgf and the sliding speed of 2.5 mm/sec is defined as X, and the frictional force measured under the condition of the load applied to the surface layer of 70 kgf and the sliding speed of 2.5 mm/sec is defined as Y, the percent change in the frictional force, expressed as [Y−X]/X×100, is preferably from 50% to 200%, and more preferably from 80% to 140%.

The percent change can be controlled by varying the type of component A, type of component B, and the compositional ratio of component B to component A.

The surface layer may contain any compound other than component A and component B, as long as the beneficial effect according to the present disclosure is not impaired.

### First Embodiment

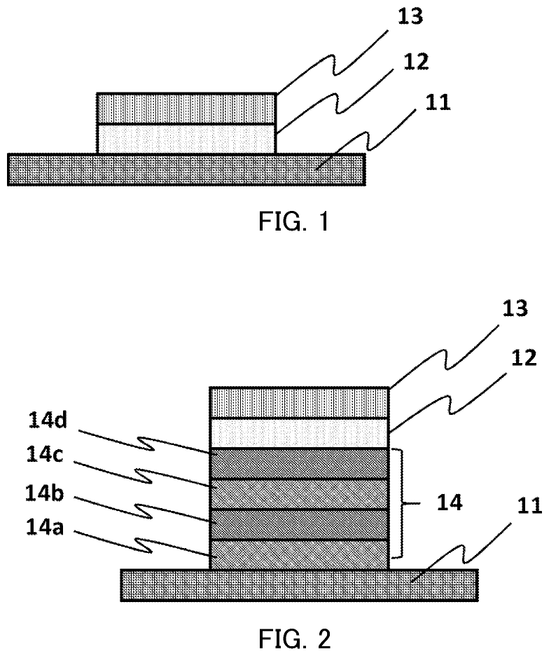

FIG. 1 is a schematic view showing an exemplary configuration of the surface layer in a first embodiment, where an undercoat layer is formed on a base material, and the surface layer is disposed on the undercoat layer.

FIG. 1 illustrates a configuration in which the undercoat layer 12 is disposed on the base material 11, and the surface layer 13 is formed on the undercoat layer 12.

Note that FIG. 1 illustrates the configuration having the surface layer schematically, and therefore, is not to scale with respect to the accurate thickness ratio between the base material 11, the undercoat layer 12, and the surface layer 13.

### (Base Material 11)

As the base material 11, any solid material may be used as long as the undercoat layer 12, the surface layer 13, or an intermediate layer 14 or a hard coating layer 15 described below can be formed on the base material, and examples thereof include glasses, ceramics, resins, and films made from materials such as glasses or resins. If any of the material mentioned above is used to form the base material for the optical member comprising the surface layer of the present disclosure, the resulting base material preferably is capable of transmitting visible light or light of a specific wavelength.

The thickness of the base material is not particularly limited, but may be appropriately set in accordance with the application thereof.

### (Undercoat Layer 12)

An undercoat layer may be formed as needed. The undercoat layer 12 serves as a substratum for the surface layer 13 formed thereon and enhances the adhesion between the base material 11 and the surface layer 13.

In the present embodiment, the undercoat layer 12 is formed on the base material 11, and the surface layer 13 is formed on the undercoat layer 12, so that the adhesion between the base material 11 and the surface layer 13 is further enhanced. The method for forming the undercoat layer is not particularly limited, but the examples include vapor deposition method, dipping method, coating method, spraying method, and spin-coating method.

The thickness of the undercoat layer 12 is not particularly limited, but ranges from 2 nm to 150 nm, and preferably from 5 nm to 125 nm.

The material to form the undercoat layer 12 preferably have surface hydroxy groups. Examples thereof include metal oxides such as SiO₂ and Al₂O₃ having surface hydroxy groups, and alkyl compounds having hydroxy groups.

### (Surface Layer 13)

The surface layer 13 corresponds to the surface layer of component A and component B of the present disclosure described above.

The thickness of the surface layer 13 is not particularly limited, but is preferably ranges from 4 nm to 20 nm. The thickness of 4 nm or more is sufficient to obtain stain-repellent properties, whereas the thickness of 20 nm or less is sufficient to obtain a good transparency. The method for forming the surface layer is not particularly limited, but the examples include vapor deposition method and coating method. Examples of the coating method include spin-coating, dip-coating, bar-coating, and spray-coating. The surface layer of component A and component B can be formed by using component A and component B in the method for forming the surface layer. The surface layer is, for example, a vapor-deposited layer. Alternatively, the surface layer is, for example, a coated layer.

### Second Embodiment

FIG. 2 is a schematic view showing an exemplary configuration of the surface layer in a second embodiment. In this configuration, an intermediate layer is formed on a base material, an undercoat layer is formed on the intermediate layer, and the surface layer is disposed on the undercoat layer.

In FIG. 2, an intermediate layer 14 is formed by alternately stacking intermediate layers 14a and 14c with a material with low refractive indices and intermediate layers 14b and 14d with a material with high refractive indices on the base material 11. On the intermediate layer 14, the undercoat layer 12 is disposed, and the surface layer 13 is formed on top of the undercoat layer 12.

Note that FIG. 2 illustrates the configuration of the surface layer schematically, and therefore, is not to scale with respect to the accurate thickness ratio between the base material 11, the intermediate layer 14, the undercoat layer 12, and the surface layer 13.

### (Intermediate Layer 14)

As shown in FIG. 2, the intermediate layer 14 consists of intermediate layers 14a and 14c with a material with low refractive indices and intermediate layers 14b and 14d with a material with high refractive indices, with the intermediate layers 14a and 14c being respectively stacked in odd-numbered positions counted from the base material 11 side, while the intermediate layers 14b and 14d are respectively stacked in even-numbered positions.

In the present embodiment, the undercoat layer 12 stacked on the intermediate layer 14 is also made of a material with a low refractive index, and the undercoat layer 12, together with the intermediate layer 14, exhibits an anti-reflective function. In the present embodiment, since the intermediate layer 14 shown as an example consists of four layers, and the undercoat layer 12 is formed on top of the intermediate layer 14d which has a material with a high refractive index, the undercoat layer 12 is preferably made of a material with a low refractive index. When the intermediate layer 14 consists of, for example, three layers and the undercoat layer 12 is formed on top of the intermediate layer 14b with a material with a high refractive index, the undercoat layer 12 is preferably made of a material with a low refractive index.

The intermediate layer 14 is not limited to the present embodiment, and a layer made of a material with a medium refractive index may be stacked as appropriate.

Examples of materials with low refractive indices include SiO₂ (silicon dioxide) and Al₂O₃ doped SiO₂ (alumina-doped silicon dioxide). However, the materials with low refractive indices are not limited thereto.

Examples of materials with high refractive indices include alumina-containing titanium oxide-lanthanum oxide-based mixed material, titanium oxide, other mixed oxides containing titanium oxide as a main component, zirconium oxide, mixed materials containing zirconium oxide as a main component, niobium oxide, mixed materials containing niobium oxide as a main component, tantalum oxide, mixed materials containing tantalum oxide as a main component, tungsten oxide, and mixed materials containing tungsten oxide as a main component. However, the materials with high refractive indices are not limited thereto.

Examples of materials with medium refractive indices include aluminum oxide, other mixed compounds containing aluminum oxide as a main component, magnesium oxide, other mixed compounds containing magnesium oxide as a main component, yttrium fluoride, and cerium fluoride. However, the materials with medium refractive indices are not limited thereto.

The thickness of the intermediate layer 14 and each layer constituting the intermediate layer 14 (14a, 14b, 14c, and 14d in FIG. 2) are not particularly limited. However, a required number of layers that constitute the intermediate layer 14, each layer having a thickness, for example, between 10 nm and 200 nm, may be stacked to form the intermediate layer 14.

Although the intermediate layer 14 described in the present embodiment consists of four layers, the present disclosure is not limited thereto in any way, and any number of layers may be employed.

The embodiment described above comprises the intermediate layer 14, which is formed by alternately stacking layers with low refractive indices and layers with high refractive indices, acting as part of an anti-reflective film; however, the present disclosure is not limited thereto. For example, at least one layer having a specific function selected from other filter or mirror, antistatic, anti-scratch hard coating, and the like may be formed between the base material 11 and the intermediate layer 14.

The base material, the undercoat layer, and the surface layer in the second embodiment of the surface layer may be the same as those in the first embodiment of the surface layer.

### <Optical Member>

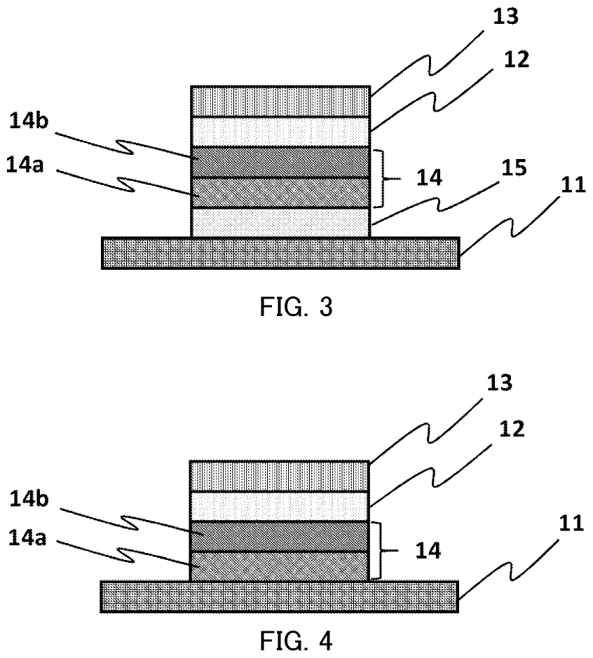

FIG. 3 is a schematic view showing the configuration of the optical member of a first embodiment.

The present embodiment is an optical member that may be used for spectacle lenses.

In the optical member shown in FIG. 3, a base material 11 made of resin, a hard coating layer 15 for preventing scratches, an intermediate layer 14 with anti-reflective function as described in the second embodiment of the surface layer, an undercoat layer 12, and a surface layer 13 are disposed. In FIG. 3, the intermediate layer 14 consists of two layers of an intermediate layer 14a with a material with a low refractive index and an intermediate layer 14b with a material with a high refractive index. The intermediate layer 14a is stacked in odd-numbered position counted from the base material 11 side, while the intermediate layer 14b is stacked in even-numbered position. However, the number of layers is not limited thereto, and any number of layers may be employed. Additionally, layers with a material with medium refractive indices may be stacked as appropriate.

Examples of the materials that may be used for the hard coating layer 15 include melamine resin, urethane resin, acrylic resin, or a blend of the above resins, and silane compounds. However, the materials used for the hard coating layer are not limited to those mentioned above.

The optical member with the configuration shown in the first embodiment is not limited to spectacle lenses, but may be used for other known applications.

FIG. 4 is a schematic view showing the configuration of the optical member of a second embodiment.

The present embodiment is an optical member that may be used as optical lenses used in devices such as cameras.

In the optical member shown in FIG. 4, a base material 11 made of glass, an intermediate layer 14 with anti-reflective function as described in the second embodiment of the surface layer, an undercoat layer 12, and a surface layer 13 are disposed. In FIG. 4, the intermediate layer 14 consists of two layers of intermediate layer 14a with a material with a low refractive index and intermediate layer 14b with a material with a high refractive index. The intermediate layer 14a is stacked in odd-numbered position counted from the base material 11 side, while the intermediate layer 14b is stacked in even-numbered position. However, the number of layers is not limited thereto, and any number of layers may be employed. Additionally, layers with a material with medium refractive indices may be stacked as appropriate.

The optical member with the configuration shown in the second embodiment is not limited to optical lenses for cameras, but may also be used in optical filters, touch panels for displays, various films, and the like.

### <Eyeglasses>

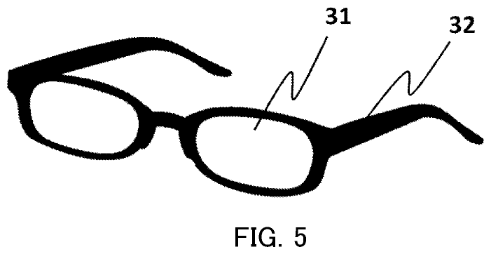

FIG. 5 is a schematic view showing the configuration of one embodiment of spectacles using the optical member of the present disclosure.

The present embodiment is constituted by a spectacle lens 31, which is the optical member of the present disclosure described above, and a spectacle frame 32.

The material for forming the surface layer of the present disclosure is a material for forming a surface layer comprising at least component A and component B, wherein
the component A has at least a siloxane segment containing a siloxane bond,
the component B is an alkyl compound having an organic segment having at least one bond selected from the group consisting of a saturated hydrocarbon bond, an unsaturated hydrocarbon bond, a carbon-oxygen double bond, and a carbon-nitrogen double bond, and having a structure represented by the following general formula (3):

$${R}_{3} - Y - {R}_{4} \qquad ( 3 )$$

a segment represented by Y comprises one or more segments containing at least one bond selected from the group consisting of [CᵢH₂ᵢ₋₂]ⱼ₁, [CᵢH₂ᵢ]ⱼ₂, [C₆H₄]ⱼ₃, [Cᵢ₊₁H₂ᵢ₋₁Cl]ⱼ₄, [CᵢHᵢCl]ⱼ₅, [C₅H₄O₃]ⱼ₆, [C₃H₆N]ⱼ₇, and [C₄H₆O₂N]ⱼ₈,
the i, j₁, j₂, j₃, j₄, j₅, j₆, j₇, and j₈ satisfy 32≤i×(i+j₂+j₃+j₄+j₅+j₆+j₇+j₈)≤750,
the j₁, j₂, j₃, j₄, j₅, j₆, j₇, and j₈ are each independently an integer of 0 or more, and
the i is, independently for each of the segment, an integer of 1 or more; and
the R₃ and R₄ are each independently a hydrolyzable group, a silanol group, a hydroxy group, a reactive organic group, an organic group containing a hydrolyzable group-containing silyl group, an alkylsilyl group, or a hydrogen atom, and
a mass ratio of the component B to the component A in the material for forming the surface layer is from 0.04 to 3.00.

Hereinbelow, the material for forming the surface layer according to the present disclosure will be described.

Component A and component B constituting the material for forming the surface layer of the present disclosure are the same as component A and component B constituting the surface layer of the present disclosure.

The mass ratio between component A and component B in the material for forming the surface layer of the present disclosure is such that the mass of component B ranges from 0.04 to 3.00 relative to the mass of component A as 1. In other words, the mass ratio of component B to component A in the material for forming the surface layer is from 0.04 to 3.00. The mass ratio is preferably from 0.10 to 1.00, and more preferably from 0.20 to 0.60.

When the mass ratio of component B to component A is less than 0.04, the surface layer formed by using the material for forming the surface layer can exhibit stain-repellent properties; however, the frictional force under high load during machining the base material having the surface layer or the optical member having the surface layer cannot be increased, resulting in insufficient suppression of slipping, which makes the machining the base material or the optical member difficult. Whereas when the mass ratio of component B to component A is more than 3.00, not only are the stain-repellent properties of the surface layer formed using the material for forming the surface layer decreased, but a higher frictional force is also generated even when the load is within the range typically applied by users during normal daily use, which cause problems such as cleaning cloth snagging on the surface layer, making the surface layer uncomfortable to use.

The mass ratio of component B to component A in the material for forming the surface layer may be determined by liquid chromatography-mass spectrometry. Alternatively, it is possible to determine the mass ratio between component A and component B by weighing them using a balance at the time when the material for forming the surface layer is prepared.

The material for forming the surface layer according to the present disclosure is not particularly limited as long as the mass ratio of component B to component A is within the range from 0.04 to 3.00, and the material for forming the surface layer may also contain materials other than component A and component B. The material for forming the surface layer may be solid or liquid. For example, component A and component B may be dissolved in an organic solvent such as hexane or toluene to yield a solution, that is a liquid. When the surface-forming material is a liquid, the surface layer may be formed by a coating method.

The surface-forming material may contain organic solvents. The organic solvents are not particularly limited, but the examples include at least one solvent selected from the group consisting of ketone-based solvents such as acetone and methyl ethyl ketone; ether-based solvents such as dimethylether, diethylether, tetrahydrofuran; aromatic hydrocarbon-based solvents such as benzene, toluene, chlorobenzene, xylene; and aliphatic hydrocarbon-based solvents such as isohexane (i.e., 2-methylpentane), 3-methylpentane, 2,2-dimethylbutane, and 2,3-dimethylbutane, normal hexane, heptane, cyclohexane.

The content of the organic solvent in the material for forming the surface layer is not particularly limited, but, for example, it may be from 50 to 150 parts by mass relative to the total content of component A and component B as 100 parts by mass.

### EXAMPLES

The present disclosure will be described more specifically by way of examples hereinbelow; however, the present disclosure is not limited by the following examples.

### Example 1

### (Preparation of Material for Forming the Surface Layer)

The compound (A-3) listed in Table 2-1 as component A and the compound (a-3) listed in Table 5 as component B were blended in a metal container in a mass ratio of component B to component A of 0.20, to yield a material for forming the surface layer 1.

### (Preparation of Undercoat Layer)

On a borosilicate glass plate, which serves as the base material 11, with a thickness of 3 mm, an undercoat layer 12 of SiO₂ with a thickness of 10 nm was formed by a vapor deposition method using a vacuum evaporator (dome diameter (D: 900 mm, deposition distance: 890 mm). The thickness of the undercoat layer 12 was determined using ellipsometry (ESM300, manufactured by JA WOOLLAM Company).

### (Preparation of Surface Layer)

On the undercoat layer 12, a surface layer 13 of the present disclosure made of the material for forming the surface layer 1 was formed by a vapor deposition method using a vacuum evaporator (dome diameter (D: 900 mm, deposition distance: 890 mm), to thereby yield an optical member of Example 1. The thickness of the surface layer 13 was determined using ellipsometry (ESM300, manufactured by JA WOOLLAM Company), and was found to be 10 nm. Furthermore, the compositional ratio of component B to component A in the thus obtained surface layer was determined using a micro-Raman spectrometer, and was found to be 0.20, which agrees with the mass ratio of component B to component A in the material for forming the surface layer.

The configuration of the thus obtained optical member is the same as that of the optical member comprising the surface layer of the present disclosure shown in FIG. 1.

### (Evaluation of Frictional Force)

The frictional force generated on the surface layer of the thus obtained optical member was measured in accordance with the following method:

Automatic Friction Abrasion Analyzer, Triboster 500, manufactured by Kyowa Interface Science Co., Ltd. was used as the device for measuring the frictional force. A rubber pad (lens blocking pad, manufactured by 3M company) cut in size to 2 mm² was used as a contact probe for measuring the frictional force. The frictional force was measured by bringing the rubber pad into contact with the surface layer of the optical member. During this test, the load applied to the surface layer was controlled by the device to be either 14 kgf or 70 kgf. This test was conducted under the condition of the sliding speed of 2.5 mm/sec. The results are shown in Table 7-1.

### (Evaluation of Stain-Repellent Properties)

The stain-repellent properties of the surface layer of the prepared optical member were measured in accordance with the following method:

The degree of repellency and the ease of wiping off highlighter pen ink were used as measures for evaluating stain-repellent properties and were evaluated according to the following criteria. The results are shown in Table 7-1.

### (Evaluation Criteria)

A: After the pen tip was brought into contact with the surface layer, the ink was repelled and gathered into spherical drops in 1 to 5 seconds and could be wiped off with a Clint paper.
B: After the pen tip was brought into contact with the surface layer, the ink was not repelled for longer than 5 seconds and could only be wiped off by hard rubbing with a Clint paper.

### Examples 2 to 214

Except that the compounds listed in Table 2-1 and Table 2-2 were used as component A, the compounds listed in Table 5 and Table 6 were used as component B, and the compositional ratio of component B to component A in the formed surface layer was altered as shown in Table 7-1, Table 7-2, Table 8-1, and Table 8-2, the same procedure as in Example 1, including blending in a metal container, preparation of the material for forming the surface layer, and the subsequent formation of the undercoat layer and the surface layer, was repeated, thereby producing the optical member having a surface layer of the present disclosure. The frictional force measurement and the evaluation of the stain-repellent performance were also conducted as in Example 1. The results are shown in Table 7-1, Table 7-2, Table 8-1, and Table 8-2.

It was found that in Examples 2-214, as in Example 1, the compositional ratio of component B to component A in the obtained surface layer agreed with the mass ratio of component B to component A in the material for forming the surface layer.

TABLE 7-1

| | | Component | | | | |
|---|---|---|---|---|---|---|
| | Combination of | ratio on | | | | |
| | compounds of | surface | Frictional force evaluation | | | |
| | component A and | (Component | | | Percent | Stain |
| Example No. | component B | A as 1) | 14 kgf | 70 kgf | change (%) | repellent |
| Example 1 | A-3 × a-3 | 1:0.2 | 158 | 248 | 57 | A |
| Example 2 | | 1:0.4 | 197 | 368 | 87 | A |
| Example 3 | A-3 × a-4 | 1:0.04 | 139 | 250 | 81 | A |
| Example 4 | | 1:0.1 | 132 | 242 | 83 | A |
| Example 5 | | 1:0.3 | 169 | 318 | 88 | A |
| Example 215 | | 1:0.3 | 167 | 320 | 92 | A |
| Example 216 | | 1:0.3 | 187 | 348 | 86 | A |
| Example 6 | | 1:0.4 | 182 | 383 | 110 | A |
| Example 7 | | 1:0.6 | 185 | 359 | 94 | A |
| Example 8 | | 1:1.0 | 258 | 497 | 93 | A |
| Example 9 | | 1:1.5 | 247 | 463 | 87 | A |
| Example 10 | | 1:3.0 | 328 | 498 | 52 | A |
| Example 11 | A-3 × a-10 | 1:0.2 | 212 | 352 | 66 | A |
| Example 12 | | 1:0.4 | 247 | 422 | 71 | A |
| Example 13 | A-3 × b-3 | 1:0.2 | 149 | 247 | 66 | A |
| Example 14 | | 1:0.4 | 189 | 325 | 72 | A |
| Example 15 | A-3 × b-4 | 1:0.2 | 165 | 318 | 93 | A |
| Example 16 | | 1:0.4 | 187 | 385 | 106 | A |
| Example 17 | A-3 × c-2 | 1:0.2 | 157 | 263 | 68 | A |
| Example 18 | | 1:0.4 | 187 | 390 | 109 | A |
| Example 19 | A-3 × d-1 | 1:0.2 | 145 | 257 | 77 | A |
| Example 20 | | 1:0.6 | 155 | 298 | 92 | A |
| Example 21 | | 1:1.0 | 195 | 318 | 63 | A |
| Example 22 | A-3 × d-3 | 1:0.2 | 140 | 248 | 77 | A |
| Example 23 | | 1:0.4 | 152 | 278 | 83 | A |
| Example 24 | A-8 × a-2 | 1:0.2 | 163 | 274 | 68 | A |
| Example 25 | | 1:0.4 | 170 | 305 | 79 | A |
| Example 26 | A-8 × a-5 | 1:0.2 | 168 | 289 | 72 | A |
| Example 27 | | 1:0.4 | 181 | 322 | 78 | A |
| Example 28 | A-8 × a-8 | 1:0.2 | 192 | 325 | 69 | A |
| Example 29 | | 1:0.4 | 205 | 357 | 74 | A |
| Example 30 | A-8 × a-11 | 1:0.2 | 225 | 364 | 62 | A |
| Example 31 | | 1:0.4 | 258 | 435 | 69 | A |
| Example 32 | A-8 × b-1 | 1:0.2 | 145 | 238 | 64 | A |
| Example 33 | | 1:0.4 | 182 | 315 | 73 | A |
| Example 34 | A-8 × b-4 | 1:0.2 | 172 | 339 | 97 | A |
| Example 35 | | 1:0.4 | 185 | 402 | 117 | A |
| Example 36 | | 1:0.8 | 243 | 482 | 98 | A |
| Example 37 | | 1:1.2 | 250 | 475 | 90 | A |
| Example 38 | | 1:2.0 | 287 | 483 | 68 | A |
| Example 39 | A-8 × b-5 | 1:0.2 | 222 | 357 | 61 | A |
| Example 40 | | 1:0.4 | 249 | 420 | 69 | A |
| Example 41 | A-8 × c-1 | 1:0.2 | 149 | 252 | 69 | A |
| Example 42 | | 1:0.4 | 178 | 352 | 98 | A |
| Example 43 | A-8 × d-1 | 1:0.2 | 142 | 253 | 78 | A |
| Example 44 | | 1:0.4 | 153 | 295 | 93 | A |

TABLE 7-2

| | | Component | | | | |
|---|---|---|---|---|---|---|
| | Combination of | ratio on | | | | |
| | compounds of | surface | Frictional force evaluation | | | |
| | component A and | (Component | | | Percent | Stain |
| Example No. | component B | A as 1) | 14 kgf | 70 kgf | change (%) | repellent |
| Example 45 | A-11 × a-3 | 1:0.2 | 157 | 249 | 59 | A |
| Example 46 | | 1:0.4 | 195 | 372 | 91 | A |
| Example 47 | A-11 × a-4 | 1:0.2 | 158 | 287 | 82 | A |
| Example 48 | | 1:0.4 | 180 | 379 | 111 | A |
| Example 49 | A-11 × b-2 | 1:0.2 | 149 | 238 | 60 | A |
| Example 50 | | 1:0.4 | 182 | 362 | 99 | A |
| Example 51 | A-11 × b-4 | 1:0.2 | 166 | 315 | 90 | A |
| Example 52 | | 1:0.4 | 185 | 390 | 111 | A |
| Example 53 | A-11 × d-4 | 1:0.2 | 141 | 250 | 77 | A |
| Example 54 | | 1:0.4 | 151 | 280 | 85 | A |
| Example 55 | A14 × a-3 | 1:0.2 | 128 | 208 | 63 | A |
| Example 56 | | 1:0.4 | 138 | 234 | 70 | A |
| Example 57 | A-14 × a-6 | 1:0.2 | 142 | 235 | 65 | A |
| Example 58 | | 1:0.4 | 175 | 342 | 95 | A |
| Example 59 | A-14 × b-3 | 1:0.2 | 127 | 205 | 61 | A |
| Example 60 | | 1:0.4 | 135 | 230 | 70 | A |
| Example 61 | A-14 × d-3 | 1:0.2 | 125 | 217 | 74 | A |
| Example 62 | | 1:0.4 | 135 | 256 | 90 | A |
| Example 63 | A-18 × a-2 | 1:0.2 | 162 | 259 | 60 | A |
| Example 64 | | 1:0.4 | 205 | 359 | 75 | A |
| Example 65 | A-18 × a-6 | 1:0.2 | 165 | 280 | 70 | A |
| Example 66 | | 1:0.4 | 207 | 407 | 97 | A |
| Example 67 | A-18 × a-11 | 1:0.2 | 178 | 285 | 60 | A |
| Example 68 | | 1:0.4 | 212 | 395 | 86 | A |
| Example 69 | A-18 × b-4 | 1:0.2 | 158 | 278 | 76 | A |
| Example 70 | | 1:0.4 | 202 | 398 | 97 | A |
| Example 71 | B-3 × a-4 | 1:0.2 | 187 | 291 | 56 | A |
| Example 72 | | 1:0.4 | 204 | 412 | 102 | A |
| Example 73 | B-3 × a-14 | 1:0.2 | 205 | 321 | 57 | A |
| Example 74 | | 1:0.4 | 225 | 432 | 92 | A |
| Example 75 | B-3 × b-4 | 1:0.2 | 187 | 295 | 58 | A |
| Example 76 | | 1:0.4 | 192 | 421 | 119 | A |
| Example 77 | B-3 × c-1 | 1:0.2 | 200 | 307 | 54 | A |
| Example 78 | | 1:0.4 | 212 | 415 | 96 | A |
| Example 79 | C-1 × a-2 | 1:0.2 | 181 | 296 | 64 | A |
| Example 80 | | 1:0.4 | 198 | 395 | 99 | A |
| Example 81 | C-1 × a-6 | 1:0.2 | 185 | 312 | 69 | A |
| Example 82 | | 1:0.4 | 221 | 435 | 97 | A |
| Example 83 | C-1 × b-1 | 1:0.2 | 180 | 295 | 64 | A |
| Example 84 | | 1:0.4 | 200 | 392 | 96 | A |
| Example 85 | C-1 × b-4 | 1:0.2 | 183 | 315 | 72 | A |
| Example 86 | | 1:0.4 | 218 | 432 | 98 | A |
| Example 87 | C-1 × d-3 | 1:0.2 | 180 | 312 | 73 | A |
| Example 88 | | 1:0.4 | 205 | 425 | 107 | A |

TABLE 8-1

| | Combination of | Component ratio | | | | |
|---|---|---|---|---|---|---|
| | compounds of | on surface | Frictional force evaluation | | | |
| | component A and | (Component A | | | Percent | Stain |
| Example No. | component B | as 1) | 14 kgf | 70 kgf | change (%) | repellent |
| Example 89 | A-1 × a-1 | 1:0.4 | 192 | 351 | 83 | A |
| Example 90 | A-1 × a-4 | | 195 | 401 | 106 | A |
| Example 91 | A-2 × a-2 | | 190 | 374 | 97 | A |
| Example 92 | A-2 × b-4 | | 198 | 402 | 103 | A |
| Example 93 | A-4 × a-6 | | 189 | 411 | 117 | A |
| Example 94 | A-4 × c-1 | | 196 | 390 | 99 | A |
| Example 95 | A-5 × a-4 | | 192 | 405 | 111 | A |
| Example 96 | A-5 × a-7 | | 189 | 357 | 89 | A |
| Example 97 | A-5 × b-2 | | 195 | 408 | 109 | A |
| Example 98 | A-5 × d-1 | | 153 | 286 | 87 | A |
| Example 99 | A-6 × a-12 | | 200 | 421 | 111 | A |
| Example 100 | A-6 × a-14 | | 225 | 440 | 96 | A |
| Example 101 | A-6 × d-4 | | 151 | 295 | 95 | A |
| Example 102 | A-7 × a-1 | | 189 | 357 | 89 | A |
| Example 103 | A-7 × a-4 | | 194 | 402 | 107 | A |
| Example 104 | A-7 × d-1 | | 187 | 302 | 61 | A |
| Example 105 | A-9 × a-3 | | 188 | 365 | 94 | A |
| Example 106 | A-9 × a-6 | | 192 | 408 | 113 | A |
| Example 107 | A-9 × a-7 | | 193 | 378 | 96 | A |
| Example 108 | A-9 × d-3 | | 196 | 408 | 108 | A |
| Example 109 | A-10 × a-13 | | 202 | 459 | 127 | A |
| Example 110 | A-10 × b-5 | | 199 | 376 | 89 | A |
| Example 111 | A-10 × d-2 | | 206 | 389 | 89 | A |
| Example 112 | A-12 × a-5 | | 198 | 349 | 86 | A |
| Example 113 | A-12 × a-10 | | 190 | 452 | 138 | A |
| Example 114 | A-12 × a-11 | | 187 | 375 | 101 | A |
| Example 115 | A-12 × b-5 | | 191 | 407 | 113 | A |
| Example 116 | A-12 × d-2 | | 187 | 400 | 114 | A |
| Example 117 | A-13 × a-2 | | 190 | 374 | 97 | A |
| Example 118 | A-13 × a-4 | | 201 | 443 | 120 | A |
| Example 119 | A-13 × b-2 | | 200 | 434 | 117 | A |
| Example 120 | A-13 × d-1 | | 196 | 365 | 86 | A |
| Example 121 | A-15 × a-2 | | 189 | 369 | 95 | A |
| Example 122 | A-15 × a-12 | | 214 | 456 | 113 | A |
| Example 123 | A-15 × a-14 | | 208 | 396 | 90 | A |
| Example 124 | A-15 × d-4 | | 201 | 375 | 87 | A |
| Example 125 | A-16 × a-1 | | 192 | 375 | 95 | A |
| Example 126 | A-16 × b-1 | | 191 | 374 | 96 | A |
| Example 127 | A-16 × d-1 | | 195 | 389 | 99 | A |
| Example 128 | A-17 × a-1 | | 193 | 377 | 95 | A |
| Example 129 | A-17 × a-4 | | 201 | 406 | 102 | A |
| Example 130 | A-17 × a-13 | | 212 | 396 | 87 | A |
| Example 131 | A-17 × b-2 | | 194 | 399 | 106 | A |
| Example 132 | A-17 × d-3 | | 193 | 395 | 105 | A |
| Example 133 | A-19 × a-3 | | 187 | 364 | 95 | A |
| Example 134 | A-19 × a-11 | | 190 | 372 | 96 | A |
| Example 135 | A-19 × c-1 | | 191 | 368 | 93 | A |
| Example 136 | A-20 × a-5 | | 184 | 352 | 91 | A |
| Example 137 | A-20 × a-9 | | 187 | 370 | 98 | A |
| Example 138 | A-20 × c-2 | | 185 | 369 | 99 | A |
| Example 139 | B-1 × a-2 | | 204 | 386 | 89 | A |
| Example 140 | B-1 × b-3 | | 200 | 384 | 92 | A |
| Example 141 | B-1 × c-2 | | 201 | 384 | 91 | A |
| Example 142 | B-1 × d-1 | | 192 | 395 | 106 | A |
| Example 143 | B-2 × a-4 | | 206 | 420 | 104 | A |
| Example 144 | B-2 × a-5 | | 199 | 397 | 99 | A |
| Example 145 | B-2 × b-2 | | 195 | 425 | 118 | A |
| Example 146 | B-2 × d-3 | | 187 | 395 | 111 | A |
| Example 147 | B-4 × a-1 | | 200 | 386 | 93 | A |
| Example 148 | B-4 × a-6 | | 198 | 427 | 116 | A |
| Example 149 | B-4 × a-7 | | 195 | 388 | 99 | A |
| Example 150 | B-4 × a-10 | | 192 | 432 | 125 | A |
| Example 151 | B-4 × d-2 | | 187 | 415 | 122 | A |

TABLE 8-2

| | Combination of | Component ratio | | | | |
|---|---|---|---|---|---|---|
| | compounds of | on surface | Frictional force evaluation | | | |
| | component A and | (Component A | | | Percent | Stain |
| Example No. | component B | as 1) | 14 kgf | 70 kgf | change (%) | repellent |
| Example 152 | B-5 × a-3 | 1:0.4 | 188 | 368 | 96 | A |
| Example 153 | B-5 × a-8 | | 195 | 427 | 119 | A |
| Example 154 | B-5 × b-3 | | 188 | 371 | 97 | A |
| Example 155 | B-5 × b-6 | | 202 | 422 | 109 | A |
| Example 156 | B-5 × d-4 | | 187 | 401 | 114 | A |
| Example 157 | B-6 × a-2 | | 181 | 358 | 98 | A |
| Example 158 | B-6 × a-9 | | 182 | 361 | 98 | A |
| Example 159 | B-6 × a-12 | | 194 | 417 | 115 | A |
| Example 160 | B-6 × d-1 | | 189 | 395 | 109 | A |
| Example 161 | B-7 × a-11 | | 184 | 369 | 101 | A |
| Example 162 | B-7 × a-13 | | 201 | 447 | 122 | A |
| Example 163 | B-7 × b-5 | | 199 | 437 | 120 | A |
| Example 164 | C-2 × a-7 | | 183 | 355 | 94 | A |
| Example 165 | C-2 × a-12 | | 189 | 395 | 109 | A |
| Example 166 | C-2 × a-14 | | 182 | 358 | 97 | A |
| Example 167 | C-2 × d-2 | | 176 | 345 | 96 | A |
| Example 168 | C-3 × a-1 | | 177 | 342 | 93 | A |
| Example 169 | C-3 × a-4 | | 182 | 407 | 124 | A |
| Example 170 | C-3 × a-9 | | 178 | 345 | 94 | A |
| Example 171 | C-3 × b-3 | | 177 | 350 | 98 | A |
| Example 172 | C-3 × d-1 | | 175 | 364 | 108 | A |
| Example 173 | D-1 × a-1 | | 180 | 345 | 92 | A |
| Example 174 | D-1 × a-4 | | 187 | 404 | 116 | A |
| Example 175 | D-1 × b-1 | | 178 | 345 | 94 | A |
| Example 176 | D-1 × c-1 | | 177 | 348 | 97 | A |
| Example 177 | D-2 × a-3 | | 180 | 355 | 97 | A |
| Example 178 | D-2 × a-7 | | 180 | 356 | 98 | A |
| Example 179 | D-2 × a-8 | | 191 | 407 | 113 | A |
| Example 180 | D-2 × b-6 | | 189 | 412 | 118 | A |
| Example 181 | D-2 × d-3 | | 180 | 397 | 121 | A |
| Example 182 | D-3 × a-10 | | 194 | 411 | 112 | A |
| Example 183 | D-3 × a-13 | | 207 | 415 | 100 | A |
| Example 184 | D-3 × a-14 | | 190 | 371 | 95 | A |
| Example 185 | D-3 × b-3 | | 201 | 409 | 103 | A |
| Example 186 | D-4 × a-5 | | 190 | 374 | 97 | A |
| Example 187 | D-4 × a-6 | | 198 | 397 | 101 | A |
| Example 188 | D-4 × d-1 | | 192 | 375 | 95 | A |
| Example 189 | D-5 × a-11 | | 188 | 362 | 93 | A |
| Example 190 | D-5 × a-12 | | 194 | 401 | 107 | A |
| Example 191 | D-5 × b-6 | | 197 | 417 | 112 | A |
| Example 192 | D-5 × c-2 | | 195 | 400 | 105 | A |
| Example 193 | D-5 × d-2 | | 187 | 397 | 112 | A |
| Example 194 | D-6 × a-3 | | 184 | 358 | 95 | A |
| Example 195 | D-6 × a-9 | | 187 | 361 | 93 | A |
| Example 196 | D-6 × b-2 | | 191 | 404 | 112 | A |
| Example 197 | D-6 × b-4 | | 192 | 412 | 115 | A |
| Example 198 | D-6 × d-4 | | 187 | 395 | 111 | A |
| Example 199 | D-7 × a-2 | | 178 | 342 | 92 | A |
| Example 200 | D-7 × a-4 | | 189 | 416 | 120 | A |
| Example 201 | D-7 × b-5 | | 177 | 348 | 97 | A |
| Example 202 | E-1 × a-5 | | 181 | 347 | 92 | A |
| Example 203 | E-1 × a-6 | | 204 | 430 | 111 | A |
| Example 204 | E-1 × b-4 | | 201 | 435 | 116 | A |
| Example 205 | E-1 × d-1 | | 188 | 407 | 116 | A |
| Example 206 | E-2 × a-8 | | 205 | 428 | 109 | A |
| Example 207 | E-2 × a-11 | | 194 | 362 | 87 | A |
| Example 208 | E-2 × b-6 | | 203 | 421 | 107 | A |
| Example 209 | E-2 × d-2 | | 197 | 399 | 103 | A |
| Example 210 | E-3 × a-4 | | 199 | 418 | 110 | A |
| Example 211 | E-3 × c-1 | | 188 | 363 | 93 | A |
| Example 212 | E-3 × d-4 | | 188 | 375 | 99 | A |
| Example 213 | A-3 × d-5 | | 122 | 207 | 70 | A |
| Example 214 | A-8 × d-5 | | 130 | 211 | 62 | A |

### Comparative Example 1

The compound (A-3) listed in Table 2-1 was solely introduced into a metal container to prepare the material for forming the surface layer, and subsequently the undercoat layer and the surface layer were formed as in Example 1 to produce the optical member. The frictional force measurement and the evaluation of the stain-repellent performance were also conducted as in Example 1. The results are shown in Table 9.

### Comparative Example 2

The compound (A-8) listed in Table 2-1 was solely introduced into a metal container to prepare the material for forming the surface layer, and subsequently the undercoat layer and the surface layer were formed as in Example 1 to produce the optical member. The frictional force measurement and the evaluation of the stain-repellent performance were also conducted as in Example 1. The results are shown in Table 9.

### Comparative Example 3

The compound (B-3) listed in Table 2-2 was solely introduced into a metal container to prepare the material for forming the surface layer, and subsequently the undercoat layer and the surface layer were formed as in Example 1 to produce the optical member. The results are shown in Table 9.

### Comparative Example 4

The compound (C-1) listed in Table 2-2 was solely introduced into a metal container to prepare the material for forming the surface layer, and subsequently the undercoat layer and the surface layer were formed as in Example 1 to produce the optical member. The results are shown in Table 9.

### Comparative Example 5

The compound (D-1) listed in Table 2-2 was solely introduced into a metal container to prepare the material for forming the surface layer, and subsequently the undercoat layer and the surface layer were formed as in Example 1 to produce the optical member. The results are shown in Table 9.

### Comparative Example 6

The compound (a-3) listed in Table 5 was solely introduced into a metal container to prepare the material for forming the surface layer, and subsequently the undercoat layer and the surface layer were formed as in Example 1 to produce the optical member. The results are shown in Table 9.

### Comparative Example 7

The compound (a-4) listed in Table 5 was solely introduced into a metal container to prepare the material for forming the surface layer, and subsequently the undercoat layer and the surface layer were formed as in Example 1 to produce the optical member. The results are shown in Table 9.

### Comparative Example 8

The compound (b-3) listed in Table 5 was solely introduced into a metal container to prepare the material for forming the surface layer, and subsequently the undercoat layer and the surface layer were formed as in Example 1 to produce the optical member. The results are shown in Table 9.

### Comparative Example 9

The compound (b-4) listed in Table 5 was solely introduced into a metal container to prepare the material for forming the surface layer, and subsequently the undercoat layer and the surface layer were formed as in Example 1 to produce the optical member. The results are shown in Table 9.

### Comparative Example 10

The compound (c-1) listed in Table 5 was solely introduced into a metal container to prepare the material for forming the surface layer, and subsequently the undercoat layer and the surface layer were formed as in Example 1 to produce the optical member. The results are shown in Table 9.

### Comparative Example 11

The compound (c-2) listed in Table 5 was solely introduced into a metal container to prepare the material for forming the surface layer, and subsequently the undercoat layer and the surface layer were formed as in Example 1 to produce the optical member. The results are shown in Table 9.

### Comparative Example 12

The compound (d-1) listed in Table 6 was solely introduced into a metal container to prepare the material for forming the surface layer, and subsequently the undercoat layer and the surface layer were formed as in Example 1 to produce the optical member. The results are shown in Table 9.

### Comparative Examples 13 and 14

Except that each compound listed in Table 2-1 was used as component A, each compound listed in Table 5 was used as component B, and the compositional ratio of component B to component A in the formed surface layer was altered as described in Table 9, the same procedure as in Example 1, including the formation of the undercoat layer and the surface layer, was repeated, thereby producing the optical member. The results are shown in Table 9. It was found that in Example 13 and 14, as in Example 1, the compositional ratio of component B to component A in the obtained surface layer agreed with the mass ratio of component B to component A in the material for forming the surface layer.

TABLE 9

| | | Component | | | | |
|---|---|---|---|---|---|---|
| | Combination of | ratio on | | | | |
| | compounds of | surface | Frictional force evaluation | | | |
| | component A and | (Component | | | Percent | Stain |
| Example No. | component B | A as 1) | 14 kgf | 70 kgf | change (%) | repellent |
| Comparative | only A-3 | — | 144 | 189 | 31 | A |
| example 1 | | | | | | |
| Comparative | only A-8 | — | 145 | 187 | 29 | A |
| example 2 | | | | | | |
| Comparative | only B-3 | — | 168 | 213 | 27 | A |
| example 3 | | | | | | |
| Comparative | only C-1 | | 147 | 188 | 28 | A |
| example 4 | | | | | | |
| Comparative | only D-1 | | 168 | 213 | 27 | A |
| example 5 | | | | | | |
| Comparative | only a-3 | | O.L. | O.L. | — | B |
| example 6 | | | | | | |
| Comparative | only a-4 | | O.L. | O.L. | — | B |
| example 7 | | | | | | |
| Comparative | only b-3 | | O.L | O.L. | — | B |
| example 8 | | | | | | |
| Comparative | only b-4 | — | O.L | O.L | — | B |
| example 9 | | | | | | |
| Comparative | onlyc-1 | | O.L. | O.L | — | B |
| example 10 | | | | | | |
| Comparative | only c-2 | | O.L. | O.L. | — | B |
| example 11 | | | | | | |
| Comparative | onlyd-1 | | O.L. | O.L. | — | B |
| example 12 | | | | | | |
| Comparative | A-3 × a-4 | 1:0.01 | 145 | 200 | 41 | A |
| example 13 | | | | | | |
| Comparative | | 1:5.0 | O.L. | O.L. | — | B |
| example 14 | | | | | | |

In Table 9, “O.L.” indicates that the frictional force could not be measured due to overload.

### Example 215

Eyeglasses were prepared by machining the optical members (i.e., glass lenses) prepared as described in Example 5 and mounting the machined optical members in a commercially available frame. The frictional force measurement and the evaluation of the stain-repellent performance were conducted as in Example 1 on the optical members in the prepared spectacles. The results are shown in Table 7-1.

### Example 216

### (Preparation of Material for Forming the Surface Layer)

The compound (A-3) listed in Table 2-1 as component A and the compound (a-3) listed in Table 5 as component B were blended in a glass container in a mass ratio of component B to component A of 0.30. Subsequently, isohexane (product name: isohexane, manufactured by Tokyo Chemical Industry Co., Ltd.) of the weight equal to the total weight of component A and component B was added into the glass container containing component A and component B, and the resulting mixture was stirred until component A and component B were no longer visibly identifiable in the glass container, to thereby obtain a material for forming the surface layer 2.

### (Preparation of Surface Layer)

The optical member comprising the surface layer of the present disclosure was prepared by coating the material for forming the surface layer 2 on a borosilicate glass plate which serves as the base material 11 having a thickness of 3 mm using a bar coater, followed by drying at 25° C. for 24 hours. The frictional force measurement and the evaluation of the stain-repellent performance were also conducted as in Example 1. The results are shown in Table 7-1. As in Example 1, the compositional ratio of component B to component A in the surface layer obtained in Example 216 agreed with the mass ratio of component B to component A in the material for forming the surface layer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A surface layer comprising at least a component A and a component B, wherein
the component A has a siloxane segment containing a siloxane bond,
the component B is an alkyl compound having an organic segment having at least one bond selected from the group consisting of a saturated hydrocarbon bond, an unsaturated hydrocarbon bond, a carbon-oxygen double bond, and a carbon-nitrogen double bond, and having a structure represented by a following general formula (3):
$${R}_{3} - Y - {R}_{4} ; \qquad ( 3 )$$
a segment represented by Y comprises one or more segments containing at least one bond selected from the group consisting of [CᵢH₂ᵢ₋₂]ⱼ₁, [CᵢH₂ᵢ]ⱼ₂, [C₆H₄]ⱼ₃, [Cᵢ₊₁H₂ᵢ₋₁Cl]ⱼ₄, [CᵢHᵢCl]ⱼ₅, [C₅H₄O₃]ⱼ₆, [C₃H₆N]ⱼ₇, and [C₄H₆O₂N]ⱼ₈,
the i, j₁, j₂, j₃, j₄, j₅, j₆, j₇, and j₈ satisfy 32≤i×(i+j₂+j₃+j₄+j₅+j₆+j₇+j₈)≤750,
the j₁, j₂, j₃, j₄, j₅, j₆, j₇, and j₈ are each independently an integer of 0 or more, and
the i is, independently for each of the segment, an integer of 1 or more; and
the R₃ and R₄ are each independently a hydrolyzable group, a silanol group, a hydroxy group, a reactive organic group, an organic group containing a hydrolyzable group-containing silyl group, an alkylsilyl group, or a hydrogen atom, and
a compositional ratio of the component B to the component A in the surface layer is from 0.04 to 3.00.

2. The surface layer according to claim 1, wherein the siloxane segment containing a siloxane bond is at least one segment selected from the group consisting of dimethylsiloxane segment, diphenylsiloxane segment, methylphenylsiloxane segment, methylhydrogensiloxane segment, and phenylhydrogensiloxane segment.

3. The surface layer according to claim 1, wherein the component A is a compound having a structure represented by a following general formula (2):
$${R}_{1} - X - {R}_{2} , \qquad ( 2 )$$
a segment represented by X consists of any combination of at least one segment selected from [SiC₂H₆—O]ₘ₁, [SiC₁₂H₁₀—O]ₘ₂, [SiC₇H₈—O]ₘ₃, [SiCH₄—O]ₘ₄, and [SiC₆H₆—O]m₅:
the m₁, m₂, m₃, m₄, and m₅ satisfy 2≤m₁+m₂+m₃+m₄+m₅≤150; and
the m₁, m₂, m₃, m₄, and m₅ are each independently an integer of 0 or more, and
the R₁ and R₂ are each independently a hydrolyzable group, a silanol group, a hydroxy group, a reactive organic group, an organic group containing a hydrolyzable group-containing silyl group, an alkylsilyl group, or a hydrogen atom.

4. The surface layer according to claim 1, wherein the segment represented by Y comprises a segment containing at least one bond selected from the group consisting of a following formulae (Y-1) to (Y-10): 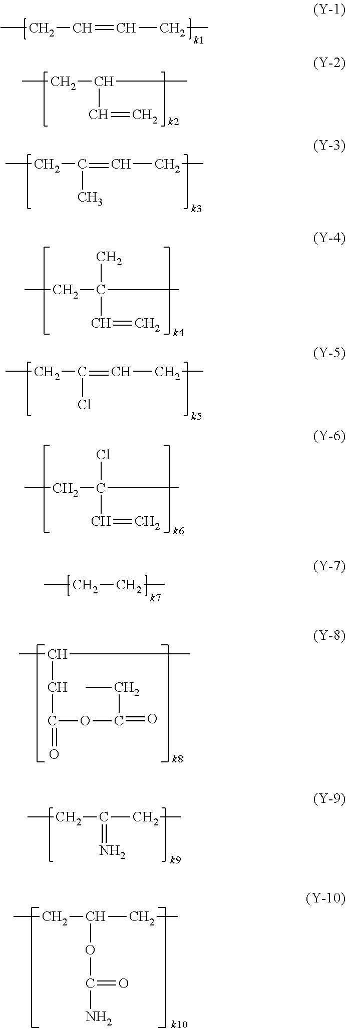
the k₁, k₂, k₃, k₄, k₈, k₆, k₇, k₈, k₉, and k₁₀ satisfy 8≤k₁+k₂+k₃+k₄+k₅+k₆+k₇+k₈+k₉+k₁₀≤180, and
the k₁, k₂, k₃, k₄, k₅, k₆, k₇, k₈, k₉, and k₁₀ are each independently an integer of 0 or more.

5. The surface layer according to claim 1, wherein
the component B has an organic segment having an unsaturated hydrocarbon bond, and
the unsaturated hydrocarbon bond is derived from at least one compound selected from the group consisting of 1,2-polybutadiene, 1,4-polybutadiene, 1,2-polyisoprene, 1,4-polyisoprene, 1,2-polychloroprene, and 1,4-polychloroprene.

6. The surface layer according to claim 1, wherein
the component B has a polyolefin having, in a side chain, an organic segment having at least one bond selected from the group consisting of an unsaturated hydrocarbon bond, a carbon-oxygen double bond, and a carbon-nitrogen double bond.

7. The surface layer according to claim 1, wherein
the component A has a dimethylsiloxane segment,
the component B has an organic segment having an unsaturated hydrocarbon bond, and
the unsaturated hydrocarbon bond is derived from at least one compound selected from the group consisting of 1,2-polybutadiene and 1,2-polyisoprene.

8. An optical member comprising the surface layer according to claim 1.

9. Eyeglasses comprising the optical member according to claim 8.

10. A material for forming a surface layer comprising at least a component A and a component B, wherein
the component A has at least a siloxane segment containing a siloxane bond,
the component B is an alkyl compound having an organic segment having at least one bond selected from the group consisting of a saturated hydrocarbon bond, an unsaturated hydrocarbon bond, a carbon-oxygen double bond, and a carbon-nitrogen double bond, and having a structure represented by a following general formula (3):
$${R}_{3} - Y - {R}_{4} ; \qquad ( 3 )$$
a segment represented by Y comprises one or more segments containing at least one bond selected from the group consisting of [CᵢH₂ᵢ₋₂]ⱼ₁, [CᵢH₂ᵢ]ⱼ₂, [C₆H₄]ⱼ₃, [Cᵢ₊₁H₂ᵢ₋₁Cl]ⱼ₄, [CᵢHᵢCl]ⱼ₅, [C₅H₄O₃]ⱼ₆, [C₃H₆N]ⱼ₇, and [C₄H₆O₂N]ⱼ₈,
the i, j₁, j₂, j₃, j₄, j₅, j₆, j₇, and j₈ satisfy 32≤i×(i+j₂+j₃+j₄+j₅+j₆+j₇+j₈)≤750,
the j₁, j₂, j₃, j₄, j₅, j₆, j₇, and j₈ are each independently an integer of 0 or more, and
the i is, independently for each of the segment, an integer of 1 or more; and
the R₃ and R₄ are each independently a hydrolyzable group, a silanol group, a hydroxy group, a reactive organic group, an organic group containing a hydrolyzable group-containing silyl group, an alkylsilyl group, or a hydrogen atom, and
a mass ratio of the component B to the component A in the material for forming the surface layer is from 0.04 to 3.00.

11. The material for forming the surface layer according to claim 10, wherein the siloxane segment containing a siloxane bond is at least one segment selected from the group consisting of dimethylsiloxane segment, diphenylsiloxane segment, methylphenylsiloxane segment, methylhydrogensiloxane segment, and phenylhydrogensiloxane segment.

12. The material for forming the surface layer according to claim 10, wherein the component A is a compound having a structure represented by a following general formula (2):
$${R}_{1} - X - {R}_{2} , \qquad ( 2 )$$
a segment represented by X consists of any combination of at least one segment selected from [SiC₂H₆—O]m₁, [SiC₁₂H₁₀—O]ₘ₂, [SiC₇H₈—O]ₘ₃, [SiCH₄—O]ₘ₄, and [SiC₆H₆—O]ₘ₅,
the m₁, m₂, m₃, m₄, and m₅ satisfy 2≤m₁+m₂+m₃+m₄+m₅≤150, and
the m₁, m₂, m₃, m₄, and m₅ are each independently an integer of 0 or more, and
the R₁ and R₂ are each independently a hydrolyzable group, a silanol group, a hydroxy group, a reactive organic group, an organic group containing a hydrolyzable group-containing silyl group, an alkylsilyl group, or a hydrogen atom.

13. The material for forming the surface layer according to claim 10, wherein the segment represented by Y comprises a segment containing at least one bond selected from the group consisting of a following formulae (Y-1) to (Y-10): 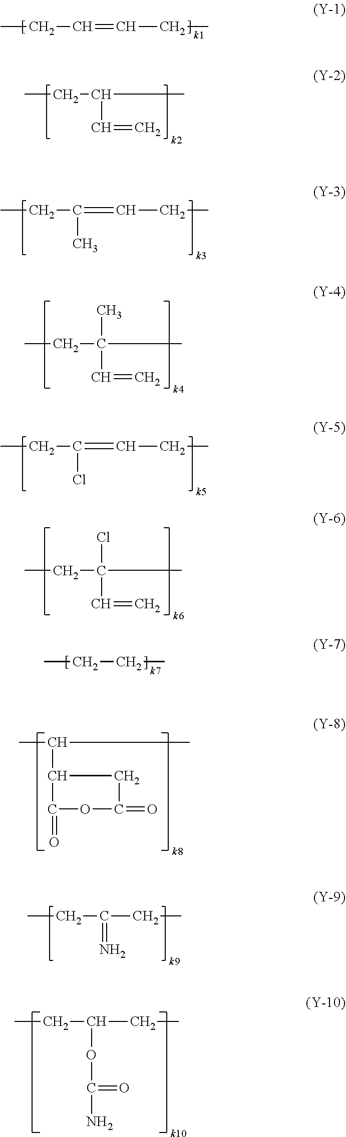
the k₁, k₂, k₃, k₄, k₅, k₆, k₇, k₈, k₉, and k₁₀ satisfy 8≤k₁+k₂+k₃+k₄+k₅+k₆+k₇+k₈+k₉+k₁₀≤180, and
the k₁, k₂, k₃, k₄, k₅, k₆, k₇, k₈, k₉, and k₁₀ are each independently an integer of 0 or more.

14. The material for forming the surface layer according to claim 10, wherein
the component B has an organic segment having an unsaturated hydrocarbon bond, and
the unsaturated hydrocarbon bond is derived from at least one compound selected from the group consisting of 1,2-polybutadiene, 1,4-polybutadiene, 1,2-polyisoprene, 1,4-polyisoprene, 1,2-polychloroprene, and 1,4-polychloroprene.

15. The material for forming the surface layer according to claim 10, wherein
the component B has a polyolefin having, in a side chain, an organic segment having at least one bond selected from the group consisting of an unsaturated hydrocarbon bond, a carbon-oxygen double bond, and a carbon-nitrogen double bond.

16. The material for forming the surface layer according to claim 10, wherein
the component A has a dimethylsiloxane segment,
the component B has an organic segment having an unsaturated hydrocarbon bond, and
the unsaturated hydrocarbon bond is derived from at least one compound selected from the group consisting of 1,2-polybutadiene and 1,2-polyisoprene.

17. A surface layer formed of the material for forming the surface layer according to claim 10.

18. An optical member comprising the surface layer according to claim 17.

19. Eyeglasses comprising the optical member according to claim 18.
